(19) United States
(12) Patent Application Publication
(10) Pub. No.: US 2018/0337432 A1
(43) Pub. Date: Nov. 22, 2018

(54) ELECTRODE MATERIAL, ELECTROLYTE, AND LITHIUM ION SECONDARY BATTERY

(71) Applicant: HON HAI PRECISION INDUSTRY CO., LTD., New Taipei (TW)

(72) Inventors: CHAN-HSIANG HSU, New Taipei (TW); MING-SHU KUO, New Taipei (TW); WEN-CHIN CHEN, New Taipei (TW); PO-YEN CHEN, New Taipei (TW); CHIN-LUNG CHIU, New Taipei (TW); FENG-YUEN DAI, New Taipei (TW)

(21) Appl. No.: 15/678,434

(22) Filed: Aug. 16, 2017

(30) Foreign Application Priority Data
May 17, 2017 (TW) 106116316

(51) Int. Cl. H01M 10/42; H01M 10/0525; H01M 10/0568; C01C 3/12

(52) U.S. Cl. CPC H01M 10/4235; H01M 10/0525; H01M 2220/20; C01C 3/12; H01M 10/0568

(57) ABSTRACT

A lithium ion secondary battery includes a positive electrode plate including a positive electrode material and a negative electrode plate including a negative electrode material. An isolation membrane and an electrolyte are also included. A Prussian Blue analogue additive is in at least one of the positive electrode plate, the negative electrode plate, and the electrolyte. When the additive is included, the additive respectively has a mass percentage of about 0.5% to about 5% of a total mass of the positive electrode material or of the negative electrode material, or of the electrolyte.

### FIELD

The subject matter generally relates to an electrode material, an electrode plate, an electrolyte, and a lithium ion secondary battery.

### BACKGROUND

Lithium ion secondary batteries are rechargeable batteries widely used in electric vehicles. In order to satisfy requirements of the electric vehicle to travel a long time, a discharge rate, an energy density, and a cycle life of the lithium ion secondary battery need to be increased. Improvement in the art is preferred.

### BRIEF DESCRIPTION OF THE DRAWINGS

Implementations of the present disclosure will now be described, by way of example only, with reference to the attached figures.

FIG. 1 is a diagram of an exemplary embodiment of a lithium ion secondary battery of the present disclosure.

FIG. 2 is a diagram of Prussian Blue analogue in the lithium ion secondary battery of FIG. 1.

FIG. 3 is a diagram of energy densities of an exemplary embodiment of the lithium ion secondary battery and a comparative example of a regular battery.

FIG. 4 is a diagram of discharge rates of an exemplary embodiment of the lithium ion secondary battery and a comparative example of a regular battery.

FIG. 5 is a diagram of cycle lives of an exemplary embodiment of the lithium ion secondary battery and a comparative example of a regular battery.

### DETAILED DESCRIPTION OF EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean at least one.

The term “comprising,” when utilized, means “including, but not necessarily limited to”; it specifically indicates open-ended inclusion or membership in the so-described combination, group, series and the like.

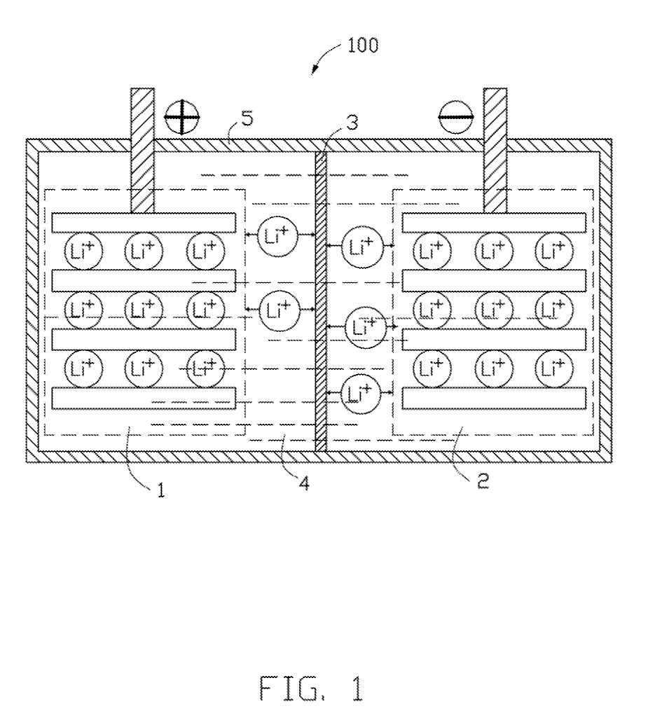

FIG. 1 illustrates an exemplary embodiment of a lithium ion secondary battery 100. The lithium ion secondary battery 100 includes a positive electrode plate 1, a negative electrode plate 2, an isolation membrane 3, an electrolyte 4, and a shell 5. The positive electrode plate 1, the negative electrode plate 2, the isolation membrane 3, and the electrolyte 4 are all received in the shell 5. The isolation membrane 3 is installed between the positive electrode plate 1 and the negative electrode plate 2. The electrolyte 4 fills the shell 5.

The positive electrode plate 1 includes a conducting collector (not shown) and a positive electrode active layer (not shown) coated on the conducting collector. The positive electrode active layer includes a positive electrode material. The positive electrode material includes a positive electrode active material, a conductive agent, an adhesive, and at least one additive.

In at least one exemplary embodiment, the additive has a mass percentage of about 0.5% to about 5% of a total mass of the positive electrode material.

In at least one exemplary embodiment, the negative electrode plate 2 includes a conducting collector (not shown) and a negative electrode active layer (not shown) coated on the conducting collector. The negative electrode active layer includes a negative electrode material. The negative electrode material includes a negative electrode active material, a conductive agent, an adhesive, and at least one additive.

The conducting collector of the positive electrode plate can be an electrolytic aluminum foil. In at least one exemplary embodiment, the electrolytic aluminum foil has a thickness of about 10 μm to about 20 μm.

The conducting collector of the negative electrode plate can be an electrolytic copper foil. In at least one exemplary embodiment, the electrolytic copper foil has a thickness of about 7 μm to about 15 μm.

The positive electrode active material is a lithium transition metal oxide, such as LiCoO₂, LiMn₂O₄, LiMnO₂, Li₂MnO₄, LiFePO₄, Li₁₊ₐMn₁₋ₓMₓO₂, LiCo₁₋ₓMₓO₂, LiFe₁₋ₓMₓPO4, LiMn_{2-y}M_{y}O₄, and Li₂Mn₁₋ₓO₄. Wherein, M can be nickel (Ni), cobalt (Co), manganese (Mn), aluminum (Al), chromium (Cr), magnesium (Mg), zirconium (Zr), molybdenum (Mo), vanadium (V), titanium (Ti) bismuth (B), fluorine (F), and yttrium (Y), or any combination thereof, 0<x<1 , 0<y<1, and 0≤a<0.2.

The negative electrode active material can be natural graphite, synthetic graphite, soft carbon, hard carbon, lithium titanate, silicon, and silicon carbide, or any combination thereof.

The conductive agent can be a carbon black conductive agent, a graphite conductive agent, a graphene conductive agent, or any combination thereof.

In at least one exemplary embodiment, the carbon black conductive agent includes acetylene black, Super P, Super S, 350G, carbon fiber(VGCF), carbon nanotube (CNT), and Ketjenblack (such as Ketjenblack EC300J, KetjenblackEC600JD, Carbon ECP, Carbon ECP600JD), or any combination thereof.

In at least one exemplary embodiment, the graphite conductive agent includes KS-6, KS-15, SFG-6, SFG-15 (trade name), or any combination thereof

The adhesive includes fluorine-containing resin, polyolefine compounds, cellulosic compounds, or any combination thereof.

The additive is a Prussian Blue analogue, which has a molecular formula of AₓM_{y}(FeCN₆).nH₂O, where A denotes an alkali element, M denotes a transition metal element. In at least one exemplary embodiment, A is potassium (K) or sodium (Na), M is iron (Fe), 0<x<2, y=1+(1−x)/3.

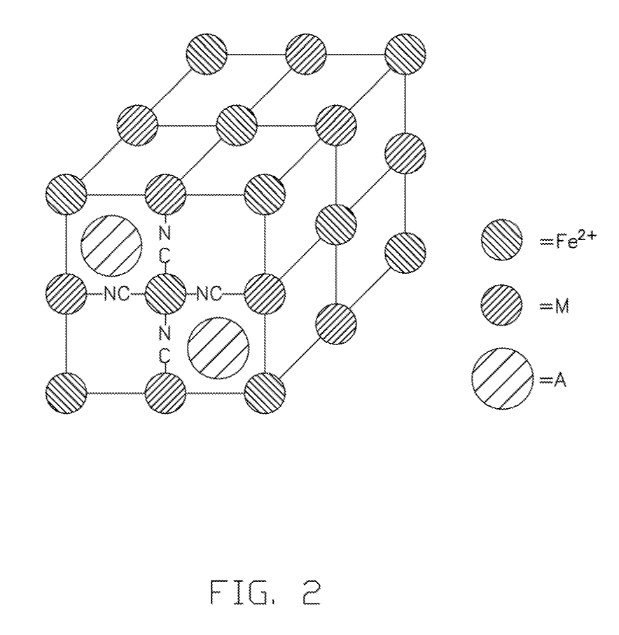

Referring to FIG. 2, the Prussian Blue analogue has a crystal structure, and the crystals have a diameter of about 100 nm to about 1000 nm.

In at least one exemplary embodiment, the diameter of the Prussian Blue analogue is about 100 nm.

The isolation membrane 3 is a porous polymer film, which allows lithium ions or alkali metal ions to pass through but prevents electrons from passing through.

In at least one exemplary embodiment, the isolation membrane 3 can be made of polypropylene or polyethylene.

In at least one exemplary embodiment, the electrolyte 4 includes a non-aqueous organic solvent and lithium salts dissolved in the non-aqueous organic solvent.

The non-aqueous organic solvent includes at least one of cyclic carbonate and chain carbonate.

The cyclic carbonate includes vinyl carbonate, propylene carbonate, and gamma-butyl ester, or any combination thereof.

The chain carbonate includes dimethyl carbonate, butene carbonate, diethyl carbonate, propyl carbonate, methyl ethyl carbonate, carbonate propyl ester, ethylene propylene carbonate, methyl formate, formic acid ethyl ester, propyl formate, methyl acetate, ethyl acetate, propyl acetate, methyl acrylic acid, propionic acid ethyl ester, and propyl propionate, or any combination thereof.

The lithium salts can be Li(FSO₂)₂N, LiPF₆, LiBF₄, LiBOB, LiODFB, LiAsF₆, Li(CF₃SO₂)₂N, LiCF₃SO₃, and LiClO₄, or any combination thereof.

In another exemplary embodiment, it is only the negative electrode material that includes the additive. The additive has a mass percentage of about 0.5% to about 5% of a total mass of the negative electrode material.

In other exemplary embodiments, only the electrolyte includes the additive. The additive has a mass percentage of about 0.5% to about 5% of a total mass of the electrolyte.

In other exemplary embodiments, at least two of the positive electrode material, the negative electrode material, and the electrolyte further include the additive. When the positive electrode material includes the additive, the additive has a mass percentage of about 0.5% to about 5% of a total mass of the positive electrode material. When the negative electrode material includes the additive, the additive has a mass percentage of about 0.5% to about 5% of a total mass of the negative electrode material. When the electrolyte includes the additive, the additive has a mass percentage of about 0.5% to about 5% of a total mass of the electrolyte.

The following equations illustrate the chemical reaction of the Prussian Blue analogue when the lithium ion secondary battery 100 is charging.

The chemical reaction in the positive electrode 1 is:

AₓMⁿ_{y}[Fe^{II}(CN)₆]-e⁻→Aₓ₋₁Mⁿ_{y}[Fe^{III}(CN)₆]+A⁻;

The chemical reaction in the negative electrode 2 is:

Aₓ₋₁Mⁿ_{y}[Fe^{III}(CN)₆]+e⁻+A⁺→AₓMⁿ_{y}[Fe^{II}(CN)₆];

The following equations illustrate the chemical reaction of the Prussian Blue analogue when the lithium ion secondary battery 100 is discharging.

The chemical reaction in the positive electrode 1 is:

Aₓ₋₁Mⁿ_{y}[Fe^{III}(CN)₆]e⁻+A⁺→AₓMⁿ_{y}[Fe^{II}(CN)₆];

The chemical reaction in the negative electrode 2 is:

AₓMⁿ_{y}[Fe^{II}(CN)₆]-e⁻→Aₓ₋₁Mⁿ_{y}[Fe^{III}(CN)₆]+A⁺_{º}

### EXAMPLE

“Example” is the battery of the instant disclosure, and “comparative example” is regular battery.

A positive electrode active material, a conductive agent, an adhesive, and at least one additive are mixed to form a positive electrode material. The positive electrode material forms a positive electrode plate of the lithium ion secondary battery 100. The positive electrode active material has a mass percentage of about 95% to about 98% of a total mass of the positive electrode material. The conductive agent has a mass percentage of about 0.5% to about 3% of the total mass of the positive electrode material. The adhesive has a mass percentage of about 0.5% to about 2% of the total mass of the positive electrode material. The additive has a mass percentage of about 0.5% to about 5% of the total mass of the positive electrode material.

### Comparative Example

A positive electrode active material, a conductive agent, and an adhesive are mixed to form a positive electrode material. The positive electrode material is used to form a positive electrode plate of a regular battery. The positive electrode active material has a mass percentage of about 95% to about 98% of a total mass of the positive electrode material. The conductive agent has a mass percentage of about 0.5% to about 3% of the total mass of the positive electrode material. The adhesive has a mass percentage of about 0.5% to about 2% of the total mass of the positive electrode material.

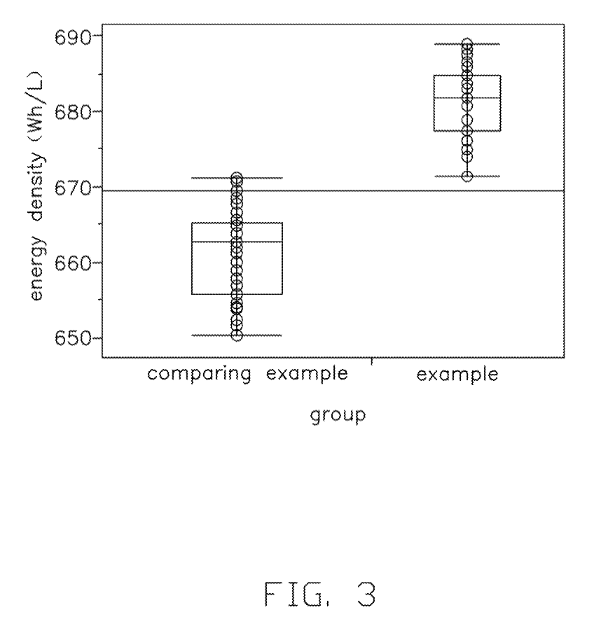

A lithium ion secondary battery 100 is made by the positive electrode plate in the example, and a battery is made by the positive electrode plate in the comparative example. An energy density, a discharge rate, and a cycle life of each of the lithium ion secondary battery 100 and the battery are tested. Wherein, the cycle life is tested under normal temperature of 25° C. when the charge rate and the discharge rate are 0.7 C/0.7 C. The test results are shown in FIGS. 3-5.

Referring to FIG. 3, the average energy density of the lithium ion secondary battery 100 in the example is 3% higher than the average energy density of the battery in the comparative example.

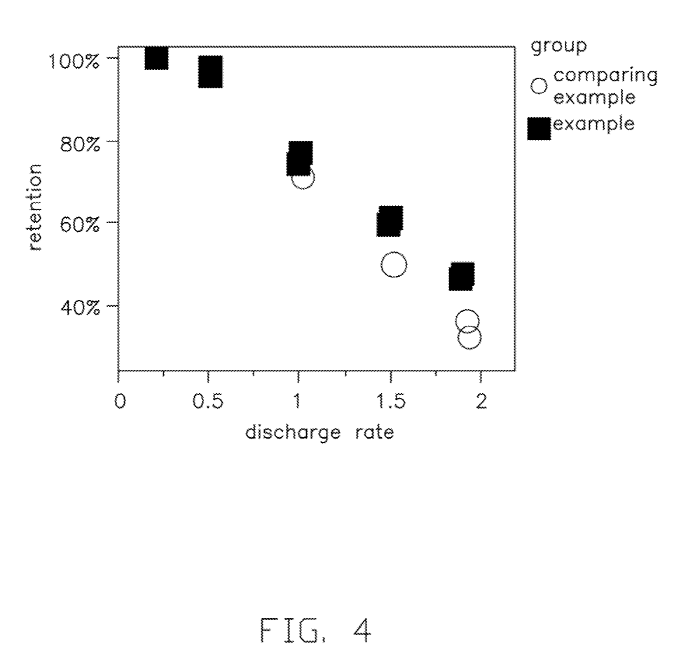

Referring to FIG. 4, the discharge rate of the lithium ion secondary battery 100 in the example is 15% higher than the discharge rate of the battery in the comparative example at discharge rate of 2 C.

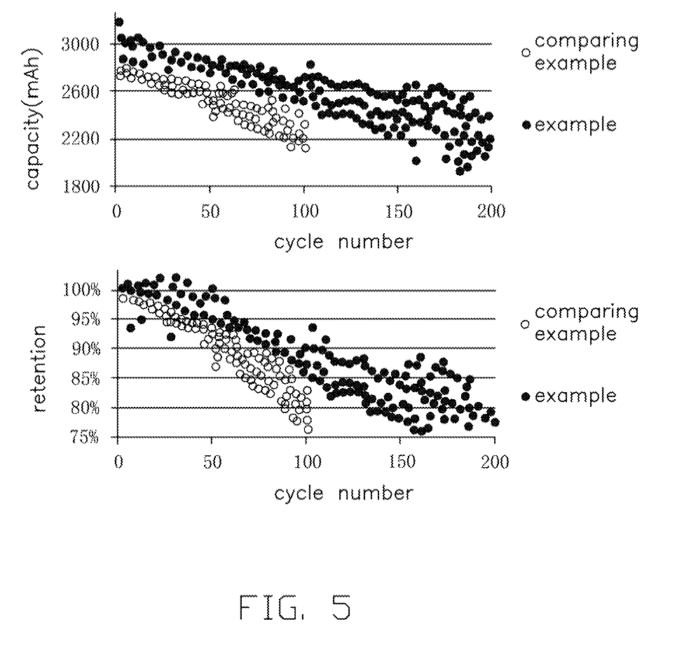

Referring to FIG. 5, the cycle life of the lithium ion secondary battery 100 in the example is 50% higher than the cycle life of the battery in the comparative example.

With the above configuration, the additive is added into at least one of the positive electrode plate, a negative electrode plate, and an electrolyte, and the additive is a Prussian Blue analogue. Thus, when the electrical potential of the lithium ion secondary battery 100 changes, the transition metal elements M undergoes an oxidation-reduction reaction, and the alkali ions A⁺ can flow back and forth between the positive electrode plate 1 to the negative electrode plate 2. Thus, the electric capacity and the average energy density of the lithium ion secondary battery 100 can be increased. Furthermore, when the alkali ions A⁺ flow away from the Prussian Blue analogue, the space for the alkali element A is empty, forming a channel to allow the lithium ions to pass through. This channel can improve ionic conductivity of the lithium ion secondary battery 100, and then the discharge rate can be improved. Moreover, the Prussian Blue analogue in the positive electrode plate or the negative electrode plate can reduce collision rates between the electrolyte and the positive electrode plate or the negative electrode plate thus can reduce irreversible reactions in the electrolyte, which would reduce the cycle life of the lithium ion secondary battery. The amount of the additive is small, so the additive cannot affect the working potential of the lithium ion secondary battery 100. Then, the additive can be applied to nearly all kinds of positive active materials, negative active materials, and electrolytes. Thus, the additive can be easily added into the lithium ion secondary battery 100.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. An electrode material comprising:
at least one additive, wherein the additive is a Prussian Blue analogue, the additive has a mass percentage of about 0.5% to about 5% of a total mass of the electrode material.

2. The electrode material of claim 1, wherein the Prussian Blue analogue has a molecular formula of AₓM_{y}(FeCN₆).nH₂O, wherein A denotes an alkali element, M denotes a transition metal element, and 0<x<2, y=1+(1−x)/3.

3. The electrode material of claim 1, wherein the Prussian Blue analogue has a crystal structure.

4. The electrode material of claim 3, wherein the Prussian Blue analogue has a diameter of about 100 nm to about 1000 nm.

5. The electrode material of claim 1, wherein the electrode material is a positive electrode material, a negative electrode material, or any combination thereof.

6. An electrolyte comprising:
at least one additive, wherein the additive is a Prussian Blue analogue, the additive has a mass percentage of about 0.5% to about 5% of a total mass of the electrolyte.

7. The electrolyte of claim 6, wherein the Prussian Blue analogue has a molecular formula of AₓM_{y}(FeCN₆).nH₂O, wherein A denotes an alkali element, M denotes a transition metal element, and 0<x<2, y=1+(1−x)/3.

8. The electrolyte of claim 6, wherein the Prussian Blue analogue has a diameter of about 100 nm to about 1000 nm.

9. A lithium ion secondary battery comprising:
a positive electrode plate, the positive electrode plate comprising a positive electrode material;
a negative electrode plate, the negative electrode plate comprising a negative electrode material;
an isolation membrane; and
an electrolyte;
wherein at least one of the positive electrode plate, the negative electrode plate, and the electrolyte comprises at least one additive, the additive is a Prussian Blue analogue, when the additive is in the positive electrode plate, the additive has a mass percentage of about 0.5% to about 5% of a total mass of the positive electrode material; wherein when the additive is in the negative electrode plate, the additive has a mass percentage of about 0.5% to about 5% of a total mass of the negative electrode material; wherein when the additive is in the electrolyte, the additive has a mass percentage of about 0.5% to about 5% of a total mass of the electrolyte.

10. The lithium ion secondary battery of claim 9, further comprising a shell, wherein the positive electrode plate, the negative electrode plate, the isolation membrane, and the electrolyte are received in the shell.

11. The lithium ion secondary battery of claim 10, wherein the isolation membrane is installed between the positive electrode plate and the negative electrode plate.

12. The lithium ion secondary battery of claim 10, wherein the electrolyte is filled in the shell.

13. The lithium ion secondary battery of claim 9, wherein the positive electrode plate comprises a conducting collector and a positive electrode active layer coated on the conducting collector.

14. The lithium ion secondary battery of claim 9, wherein the negative electrode plate comprises a conducting collector and a negative electrode active layer coated on the conducting collector.
